(19) United States
(12) Patent Application Publication
(10) Pub. No.: US 2026/0099059 A1
(43) Pub. Date: Apr. 9, 2026

(54) DOUBLE-SIDED, MULTIPLANE, BACKWARD REFRACTION IMAGING DEVICE FOR USE IN OPTICS RELATED STEM EDUCATION

(71) Applicant: University of Massachusetts, Westborough, MA (US)

(72) Inventors: Ana Doblas, Dartmouth, MA (US); Griffin Cottle, Bristol, RI (US); Francois Bouchard, Westport, MA (US)

(73) Assignee: University of Massachusetts, Westborough, MA (US)

(21) Appl. No.: 19/349,590

(22) Filed: Oct. 3, 2025

Related U.S. Application Data
(60) Provisional application No. 63/703,194, filed on Oct. 3, 2024.

(51) Int. Cl. G02B 30/36; G02B 30/56; G09B 23/22

(52) U.S. Cl. CPC G02B 30/36; G02B 30/56; G09B 23/22

(57) ABSTRACT

A STEM educational building set (i.e., apparatus) consists of a double-side multiplane imaging display device that provides two simultaneous and distinct 2D/3D scenes. Viewers with polarized goggles can observe 3D multiplane scenes (i.e., a 3D scene for each axial plane) by displaying two laterally separated images of the same scene with different polarization. The building set teaches users optics, exposing them to refraction law, lateral magnification, optical two-dimensional projection, and three-dimensional imaging.

### CROSS-REFERENCE TO RELATED APPLICATIONS

This patent document claims priority to earlier filed U.S. Provisional Application Serial No. 63/703,194, filed on October 3, 2024, the entire contents of which are incorporated herein by reference.

### BACKGROUND OF THE DISCLOSURE

### 1. Field of the Invention.

The instant invention relates to backward refraction imaging devices, and more particularly to a double-sided, multiplane imaging device for use in STEM-related education, that can project two simultaneous and distinct 2D/3D images.

### 2. Description of Related Art.

STEM toys are designed to educate children in Science, Technology, Engineering, and Mathematics while playing. These toys aim to promote learning, problem-solving, creativity, and critical thinking skills in children from a young age. STEM toys in Optics aim to introduce children to the principles of light, vision, and optical components through playful hands-on activities. Most of these toys often focus on hands-on exploration of basic concepts such as reflection, refraction, color mixing, and the behavior of light, without requiring complex instructions or fine motor skills. In other words, these toys involve simple assembly, restricting their use to children in early childhood (ages 3-6) and primary school (ages 6-12). Pre-teen and teen children are more interested in toys with more complex challenges and opportunities for creativity, critical thinking, and skill development.

This disclosure is related to educational devices, or science kits which can teach the concepts of three-dimensional (3D) imaging (“holography”), backward refraction and 3D projection. Holography is an imaging technique that creates an optical illusion to transform two-dimensional (2D) images into a 3D perspective illusion with the perception of depth. One of the most famous holographic examples is Princess Leia’s hologram from the Star Wars saga. However, 3D free-standing holograms like Princess Leia’s hologram are costly and require complex laser systems.

There are many low-cost methods of generating 3D illusions from 2D images using simple concepts of optics. For example, anaglyph glasses are based on the stereoscopic 3D effect, color encoding two laterally-shifted images of the same scene. In other words, anaglyph 3D images are composed of two differently colored images (e.g., red versus cyan) in which each of these images is only perceived by an eye. The visual cortex creates the 3D images in our brains which realizes that both images are from the same scene and composes them into a 3D scene. This same principle is also used in the polarizing goggles in which the color filters have been replaced by circular polarizers. Whereas monochrome 3D scenes are created using anaglyph glasses, the polarizing goggles generate full-color 3D scenes. While these methods are well established and fairly simple, the use of stereoscopic-based goggles may lead to some discomfort on the user’s side, such as headaches, and are thus not well-suited to extended use in children’s products.

The Pepper’s Ghost technique is another approach to create 3D illusions, but without goggles and is thus more child-friendly. The Pepper’s Ghost technique is based on Snell’s law and the law of backward refraction in which 2D images are reflected using a transparency sheet set at a 45-deg angle (see FIG. 1). A transparency sheet set at an angle of 45-degree within a viewing tunnel creates a perfect replica of the image displayed on an LCD, creating the illusion of an image floating in the air. Note that, in actuality, the image has been only refracted off by the transparency sheet. The use of 45-deg transparency sheets ensures that the holographic images' size coincides with the size of the projected image onto the LCD.

In FIG. 2, a second transparency sheet and an second LCD display are added. Since two LCDs are used, each transparency sheet creates a hologram at different axial depths looking down the viewing tunnel, generating a full-parallax three-dimensional image with depth. However, these holograms appear only on one side of the Pepper’s Ghost device since the transparency sheet refracts the images in a different direction depending on the LCD location. The bottom LCDs (named as LCD1 and LCD2 in FIG. 2 refract the images at a 45- degree angle to the right, enabling the observation of the two distinct holograms at a different axial location in the left-side of the display.

Similarly, as illustrated in FIG. 3, if the orientation of the displays is reversed and moved to the top, the holograms created by the top LCDs (e.g., LCD3 and LCD4) are only observable from the right-side of the display.

A commercial product related to the Pepper’s Ghost concept is called the Pepper’s Ghost Prism, which is a cone-shaped device that creates a 3D image. The Pepper Ghost Prism is an optical device consisting of four transparent sheets that form a prism. Each transparent sheet projects a different perspective of an object, creating a three-dimensional image inside a cone. The location (i.e., height) of the 3D image depends on the angle of the prism. The Pepper’s Ghost Prism introduces children to geometrical Optics and Snell’s law (i.e., refraction of the

light); its simplicity makes this STEM toy more suitable for children in early childhood (ages 3-6) and primary school (ages 6-12).

However, the Pepper’s Ghost Prim presents the following drawbacks: (1) only a single object can be projected, restricting its use for a complex visualization (i.e., multiple objects and a solid background); (2) the size of the three-dimensional image is restricting by the screen size since it needs to be divided into 4 regions to display each perspective view, hampering its implementation for macroscopic dimensions; and (3) the effect of 3D images is obstructed by the presence of the prism’s edges.

A Pepper’s Ghost Cone proposed by Google Inc. has overcome the last two limitations. By replacing the prism with a transparent cone, the Pepper’s Ghost Cone eliminates the prism’s edges and can project larger objects with a perspective of 360 degrees since the whole screen is used to display a single object. Notwithstanding, neither the Pepper’s Ghost Prism nor Cone can generate 3D images of multiple objects of considerably large size at the same time.

Accordingly, it is perceived that there is a need in the industry for an improved optical imaging device or self-assembled educational kit which is more suitable for pre-teen and teen students and can teach the concepts of backward refraction and 3D imaging using simple components, construction and assembly techniques.

### SUMMARY OF THE DISCLOSURE

The present invention disclosure is related to a STEM optics educational kit that provides multiple views of a three-dimensional (3D) scene, allowing any observer to perceive the 3D content from different angles and distances without wearing goggles. Such a STEM toy introduces children to 3D imaging with realistic depth perception, having applications in multiple fields including entertainment (i.e., 3D movies and virtual reality), medical imaging, scientific visualization, architectural design, and gaming. In all these applications, realistic depth perception is essential for enhancing user engagement and understanding of three- dimensional content.

According to exemplary embodiments of the invention, a modular, interlocking housing system including a central image viewing tunnel with upper and lower image projection housings.

The central image viewing tunnel includes two spaced transparency sheets which can be disposed in inner wall channels oriented at varying angles for different visual effects. The image tunnel may also include a sliding inner frame which allow the user to slide the frame outwardly of the main tunnel to easily reposition the transparency sheets.

The upper and lower image projection housings are assembled onto the top and bottom of the image viewing tunnel. Display holder frames are slidably positioned into the upper and lower housings and hold LCD display devices to project lighted images upwardly and downwardly into the image viewing tunnel. The images are backwards refracted by the transparency sheets to create 3D images viewable from each end of the viewing tunnel.

The upper and lower image projection housings may include removable front panels or doors to enclose the display devices and enhance brightness of the lighted display images into the viewing tunnel.

Therefore, using a set of two-opposed LCDs in a traditional Pepper’s Ghost configuration generates two separate holograms, enabling their distinct observation from the two sides of the device (e.g., creating a tunnel effect).

In some embodiments, the display holder frames have a single rectangular frame for a single display panel, while other embodiments may have a single frame with two spaced frame openings for two separate side-by-side display panels.

Some embodiments may include additional vertical lens slots at each end of the viewing to receive magnifying (Fresnel) lenses.

Some embodiments may include additional horizontal panel slots between the image projection housings and the image viewing tunnel to viewing to receive either a magnifying (Fresnel) lens or an opaque blocking panel.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the

invention can be more readily understood and appreciated from the following descriptions of various embodiments of the invention when read in conjunction with the accompanying drawings in which:

FIG. 1 is an illustration of a conventional prior art Pepper’s Ghost illusion from a single transparency sheet and a single display;

FIG. 2 is an illustration that expands the Pepper’s Ghost illusion to two transparency sheets and two displays generating images from below to create a 3D illusion with depth in an axial direction;

FIG. 3 is a similar illustration where the displays are reoriented to the top of the imaging tunnel and therefore visible from the opposite end of the tunnel;

FIG. 4 is an illustration of an improved Pepper’s Ghost imaging device where display devices are located both top and bottom and spaced to provide a double-sided, multiplane, backward refraction imaging device displaying different 3D images from each side of the viewing tunnel;

FIG. 5 illustrates the perceived image from the viewers perspective at each end of the viewing tunnel;

FIG. 6 is a perspective view of an exemplary embodiment of a modular housing structure in accordance with the teachings of the present invention;

FIG. 7 is another perspective view thereof;

FIG. 8 is an enlarged view of one of the image projection housings (lower housing) and an exemplary interfitting dowel and hole assembly configuration;

FIG. 9 is an enlarged view thereof;

FIG. 10 is another perspective view of the upper image projection housing showing an optional door structure that is slidably movable to allow placement of the display devices into the housing interior;

FIG. 11 is another view thereof showing placement of the display holder frames slidably

inserted into corresponding slots in the housing inner walls;

FIGS. 12-13 are views of the single display frame (E1);

FIGS. 14-15 are view of the dual display frame (E2); FIG. 16 is a view of an exemplary configuration for an inner imaging tunnel frame which can be slidably moved into and out of the imaging tunnel for placement of the transparency sheets in the angled holding slots;

FIGS. 17-18 are additional views of the sliding inner frame;

FIGS. 19-20 are views showing slots for several different angular positions of the transparency sheets;

FIG. 21 is an illustration showing the viewers perceived difference in the images when the transparency sheets are placed at 45 degrees and 30 degrees;

FIG. 22 illustrates the use of Fresnel magnifying lenses at each end of the viewing tunnel to enlarge the 3D image;

FIG. 23 illustrates the use of a Fresnel lens between the image projection housing and the image viewing tunnel; and

FIG. 24 illustrates the use of an opaque panel between the image projection housing and the image viewing tunnel to block the image from one side.

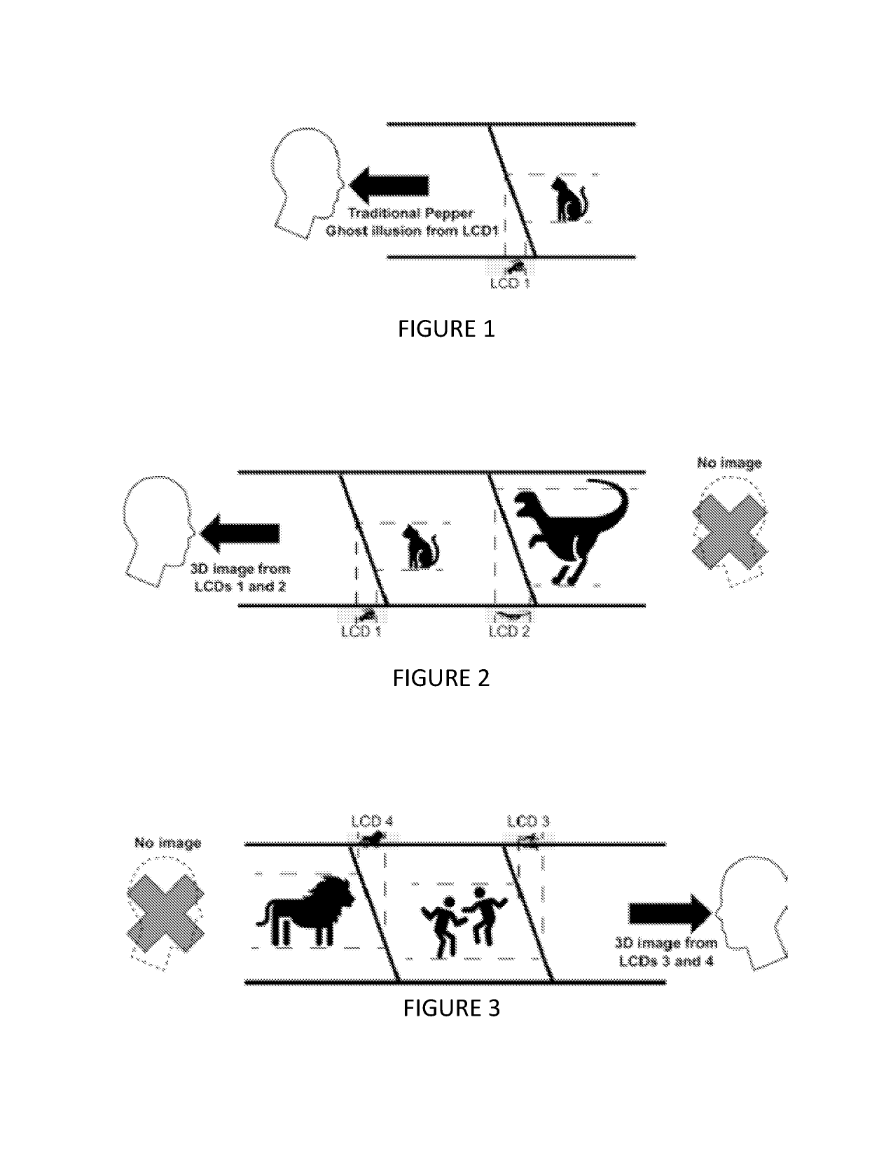

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non- limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus, within a particular embodiment, each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

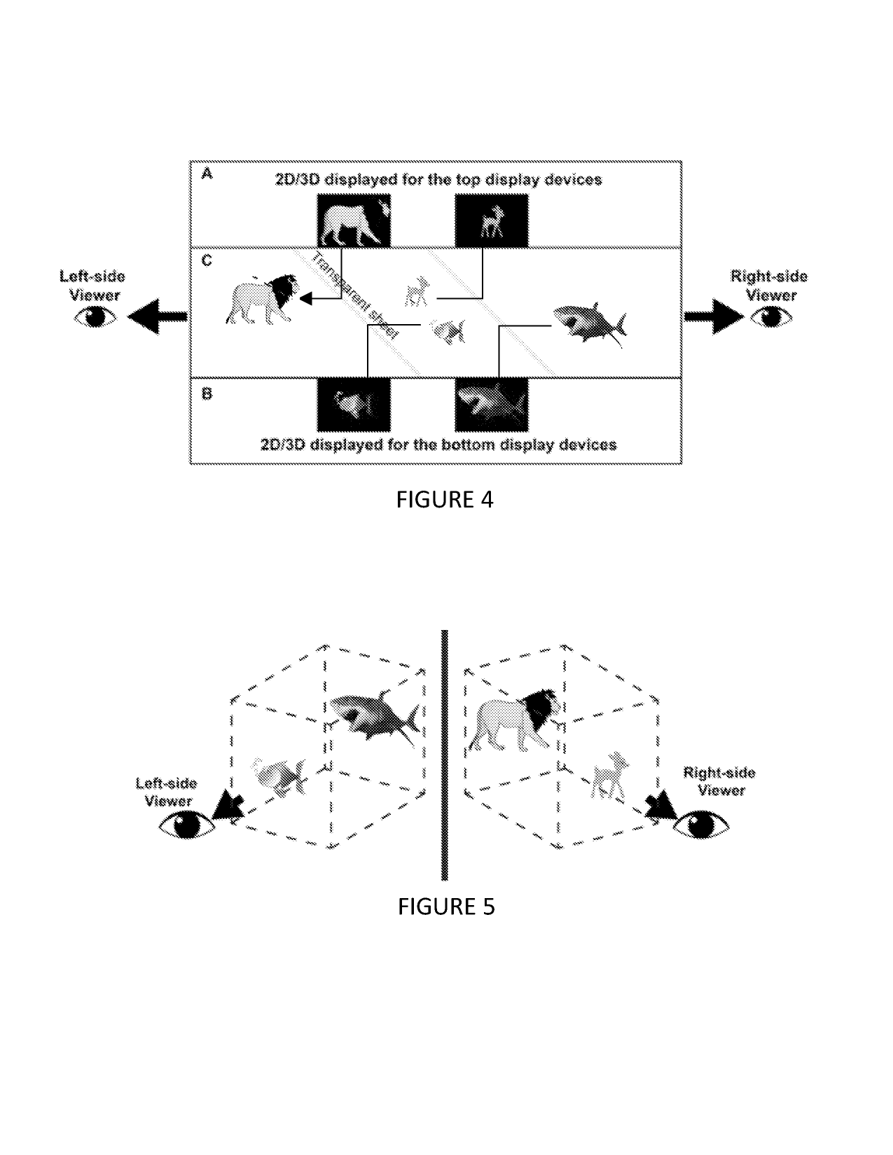

The object of this invention is to provide a building set (i.e., apparatus) for a child to construct a double-sided multiplane imaging display device that provides two simultaneous and distinct 2D/3D scenes. Viewers with polarized goggles can observe 3D multiplane scenes (i.e., a 3D scene for each axial plane) by displaying two laterally separated images of the same scene with different polarization (See FIGS. 4 and 5). Although a similar approach can be implemented by displaying the two slightly offset scenes with a different color and using anaglyph goggles (i.e., goggles with red/cyan colored filters for the left/right eye, respectively), this approach will create some color distortion based on the original color displayed on the screens. The building set teaches users concepts of optics, exposing them to refraction law, lateral magnification, optical two-dimensional projection, and three-dimensional imaging.

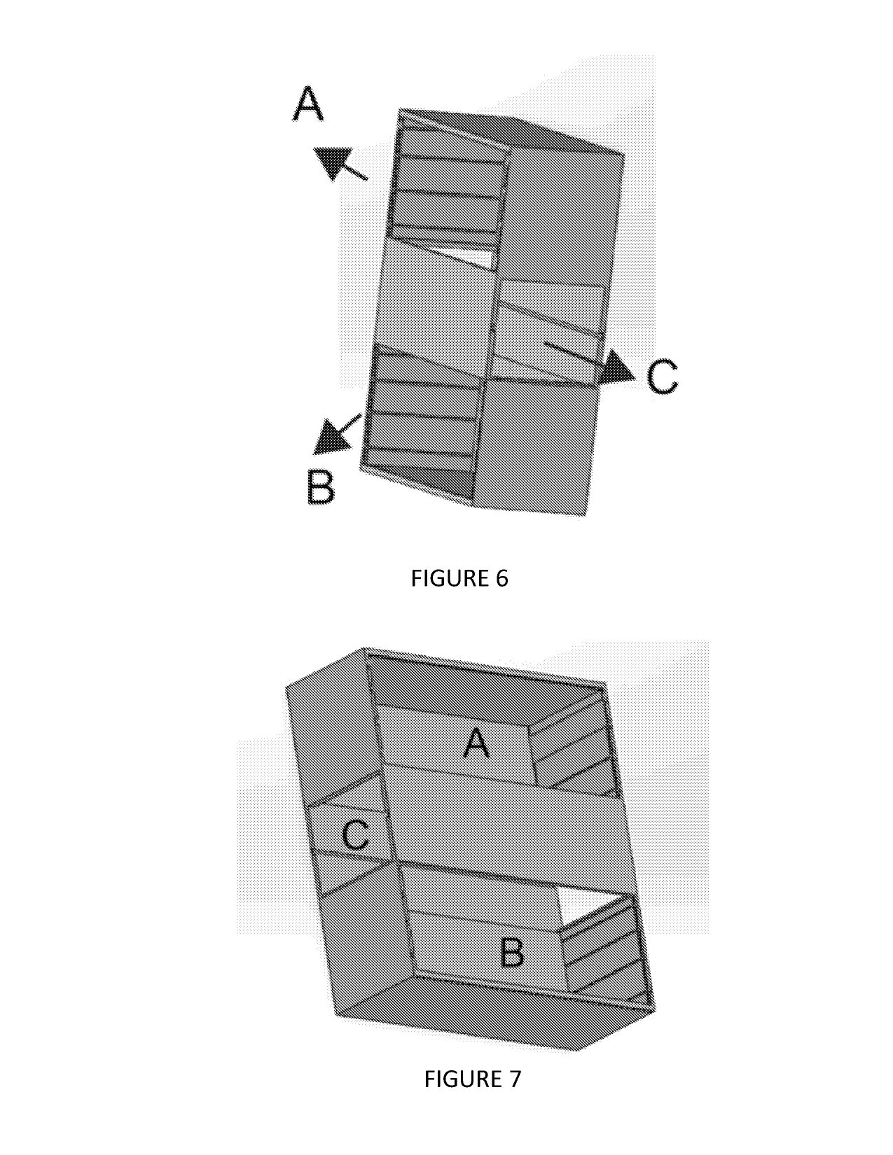

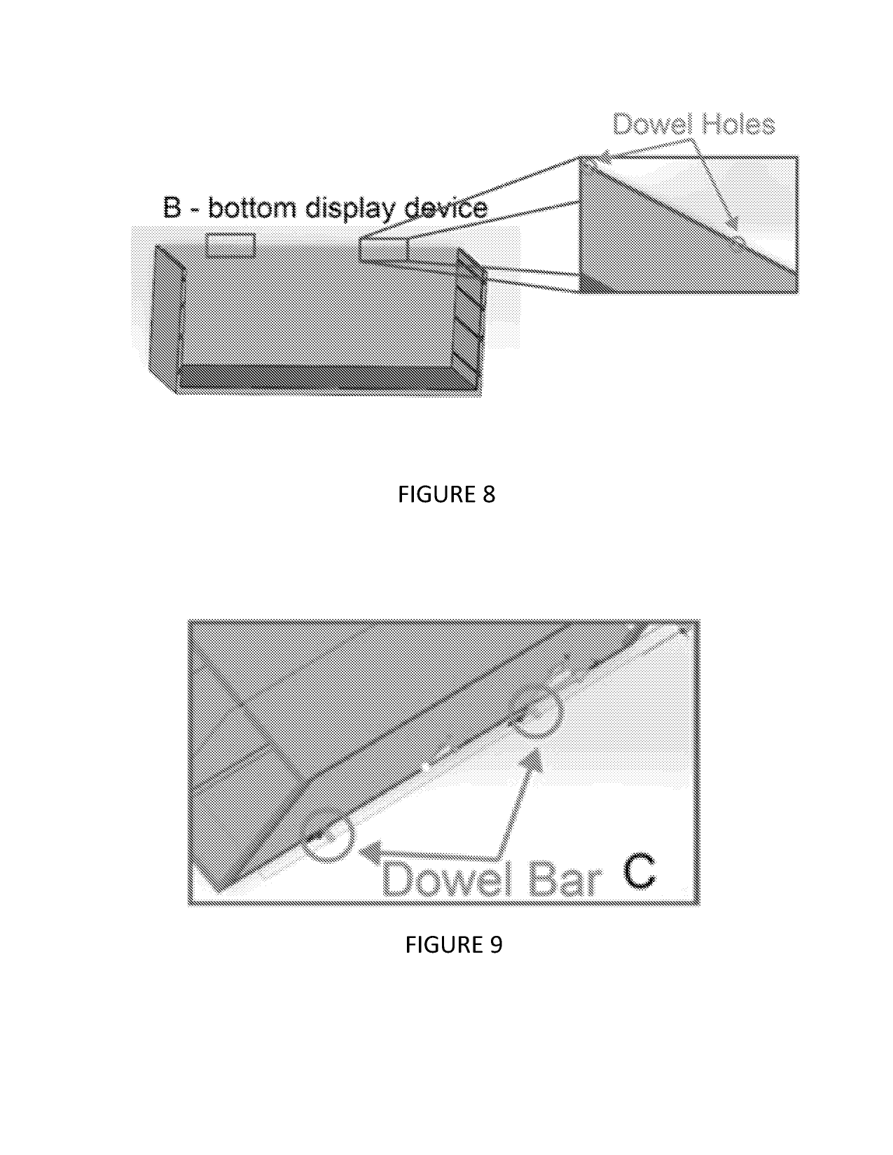

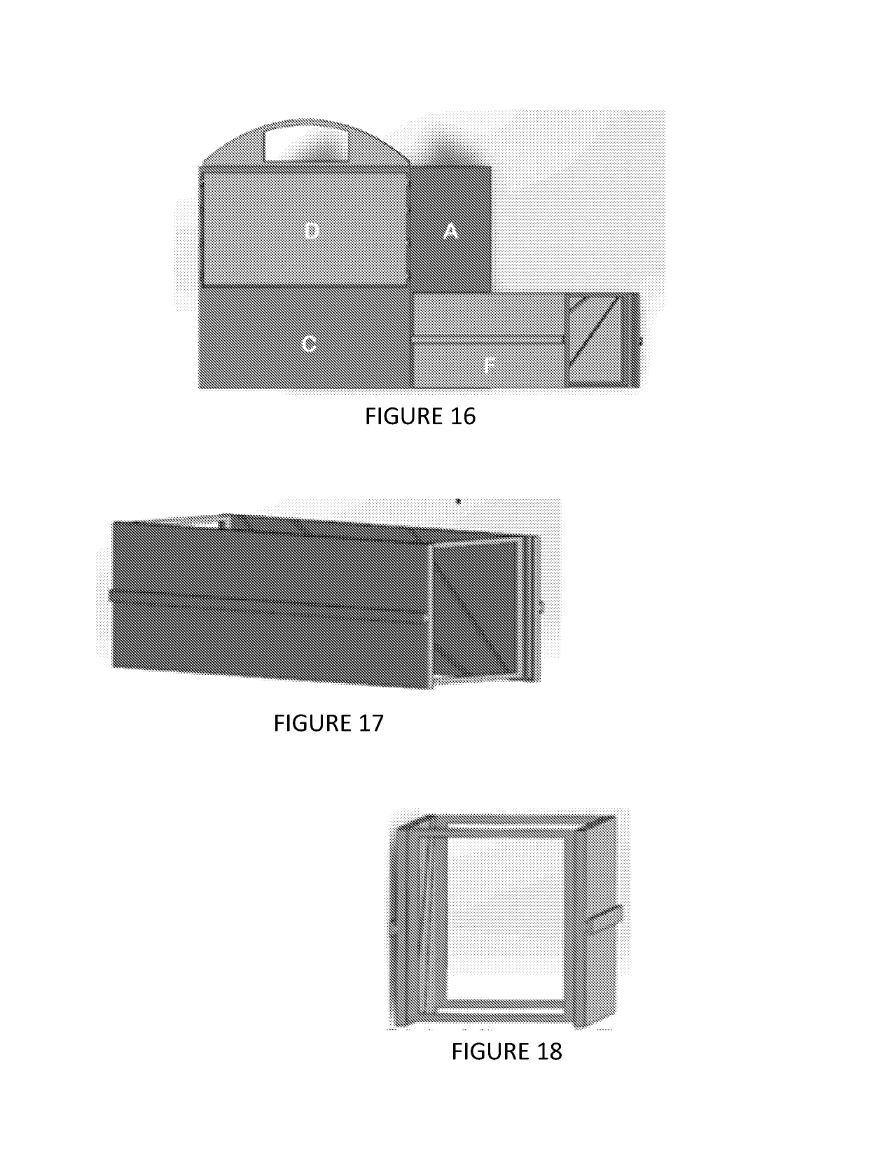

Referring to FIGS. 6-20, the building set comprises modular interlocking housing pieces including a central image viewing tunnel (C) along with upper and lower image projection housings (A) and (B). FIGS. 6 and 7 show illustrations of an exemplary frame of the STEM toy. The A and B parts of the toy frame house the top and bottom display devices (LCD screens), respectively. FIGS. 8 and 9 show enlarged views of the lower projection housing part B. The modular housing parts A and B are connected to part C using a dowel system.

Dowel bars create a highly stable foundational frame at a reduced cost. In addition, dowel bars enable a children-friendly toy assembly without requiring complex tools or adult assistance.

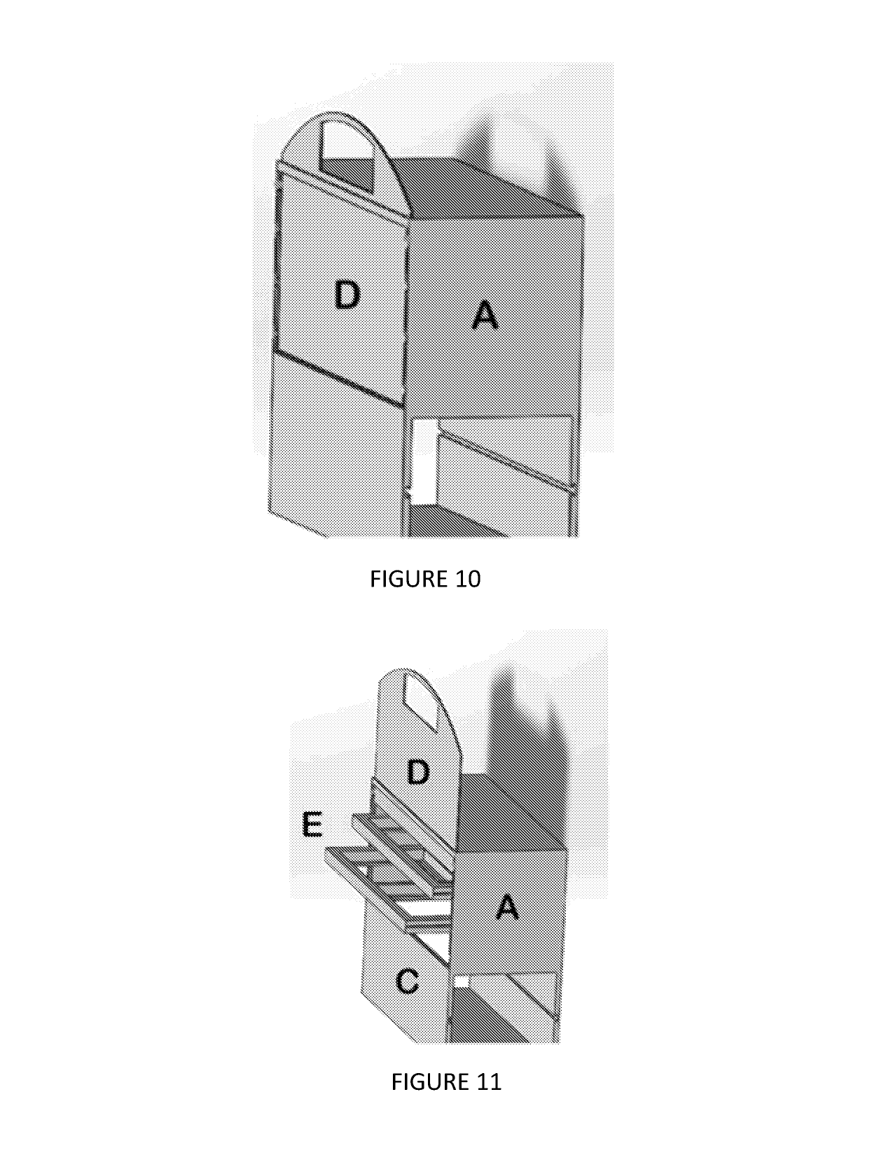

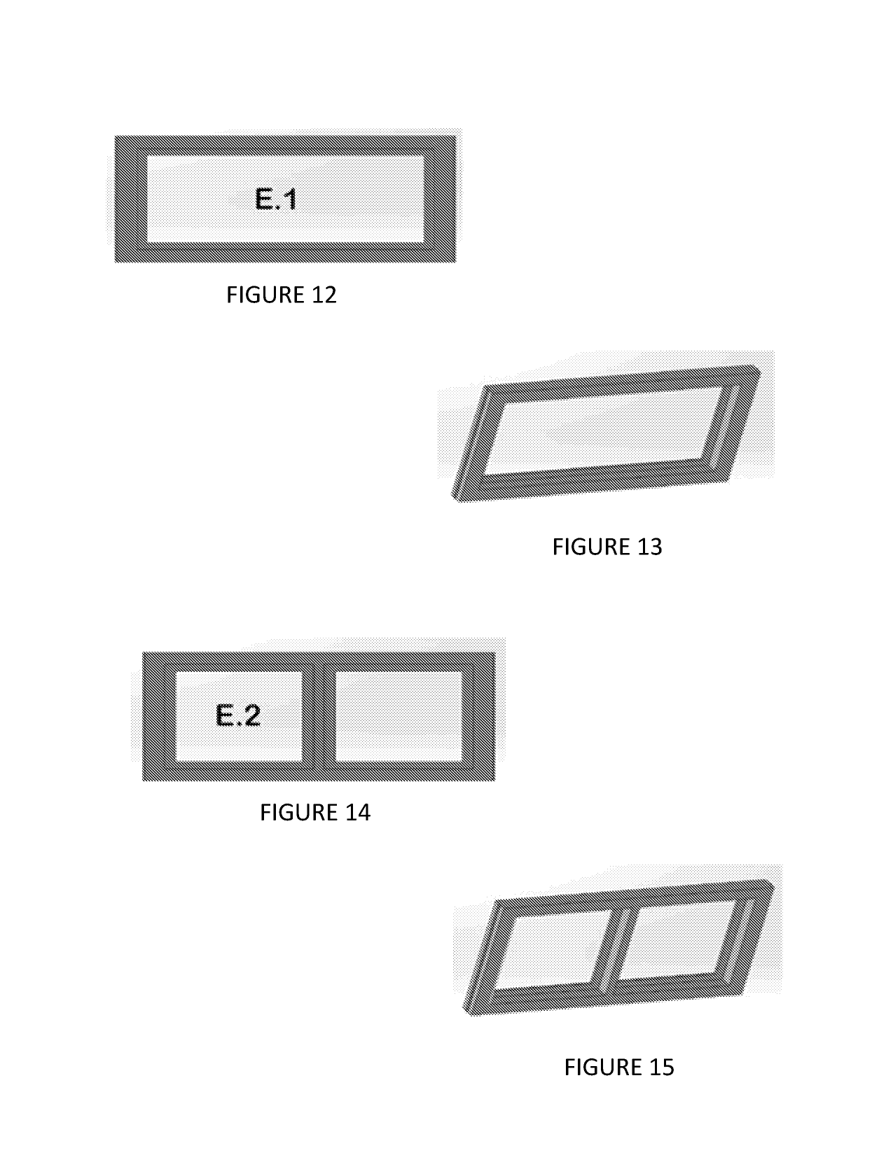

As best seen in FIGS. 6-8, the vertical walls in the A and B parts are indented or slotted, allowing children to insert the display devices which are mounted with display holder frames (E). To ensure that the display devices do not fall down due to gravity, they will be housed on display holders (parts E.1 and E.2 in FIGS. 11-15). The display holders (E) have ledges which interfit with the slots in the A and B parts to position them at various levels within the housing parts. The disclosed housing system can host multiple digital display devices, such as a mobile phone, or a large screen display using the E.1 holder in FIGS. 12-13, or two individual small sensors like Raspberry Pi screen displays using the E.2 holder in FIGS. 14-15. The user will have access to insert the display devices mounted on their corresponding holder through the front opening of the A and B projection housings. Referring to FIG. 10, a door (D) may be provided to define a space for the display devices and any required software controller. The door D may also be important to block any stray and unwanted ambient light that may reduce the contrast of the displayed/projected 2D/3D scenes. A similar door may be provided in the bottom projection housing part B.

Floating 2D/3D scenes (FIG. 5) are generated using Snell’s backward refraction law through the use of at least two spaced transparency sheets mounted at an angle within the central image display tunnel C (See FIGS. 4 and 20) . Each of these sheets projects a replica of the scene displayed on the display devices, creating the illusion of a floating scene in the air within the tunnel. FIGS. 16-20 illustrate an exemplary construction of a frame (part F in FIG. 16) that holds the transparency sheets. Part C and sliding part F are connected using an indent/ledge (shoulder and slot) system. It is important to mention that part F can be axially displaced within the main tunnel body C, enabling an axial displacement between the transparent sheets and the display devices. Such axial displacement generates an axial displacement of the floating 2D/3D scene. In other words, children can change the position of the floating 2D/3D scenes by translating the F platform.

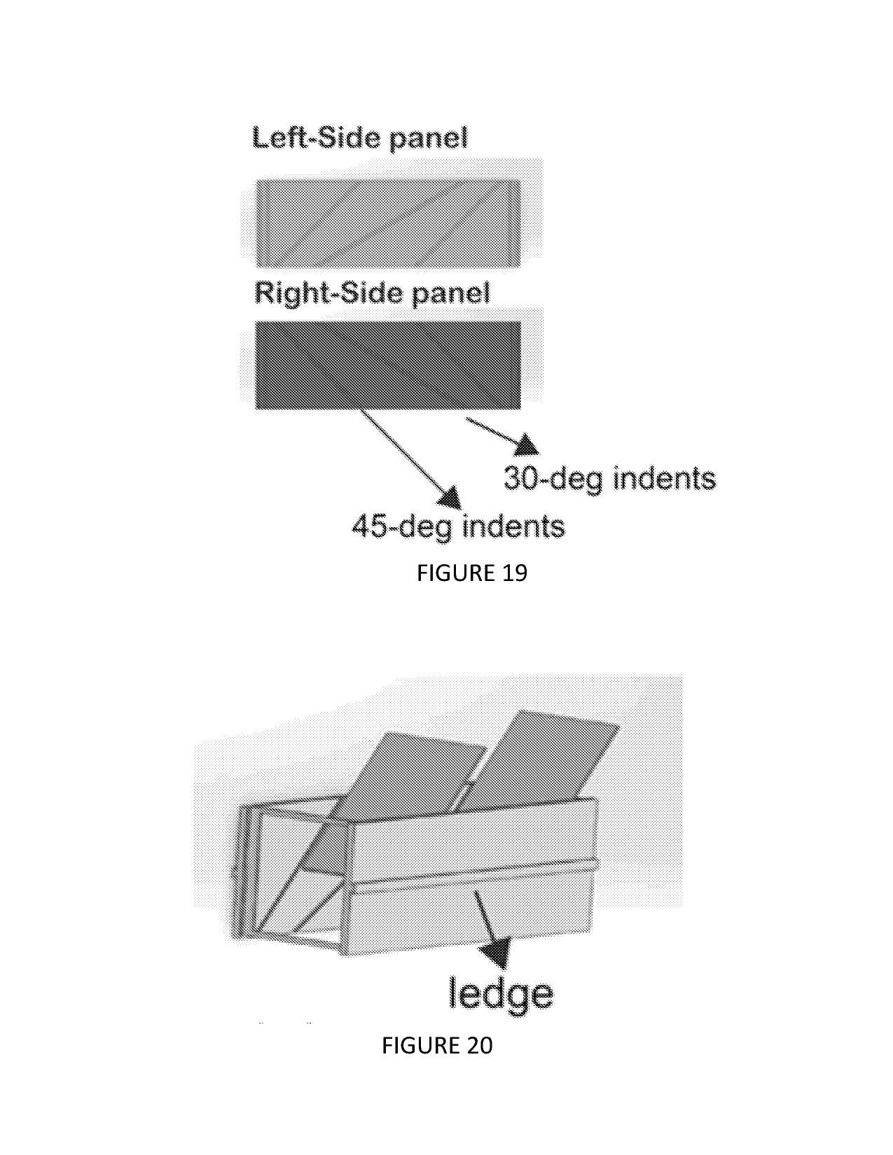

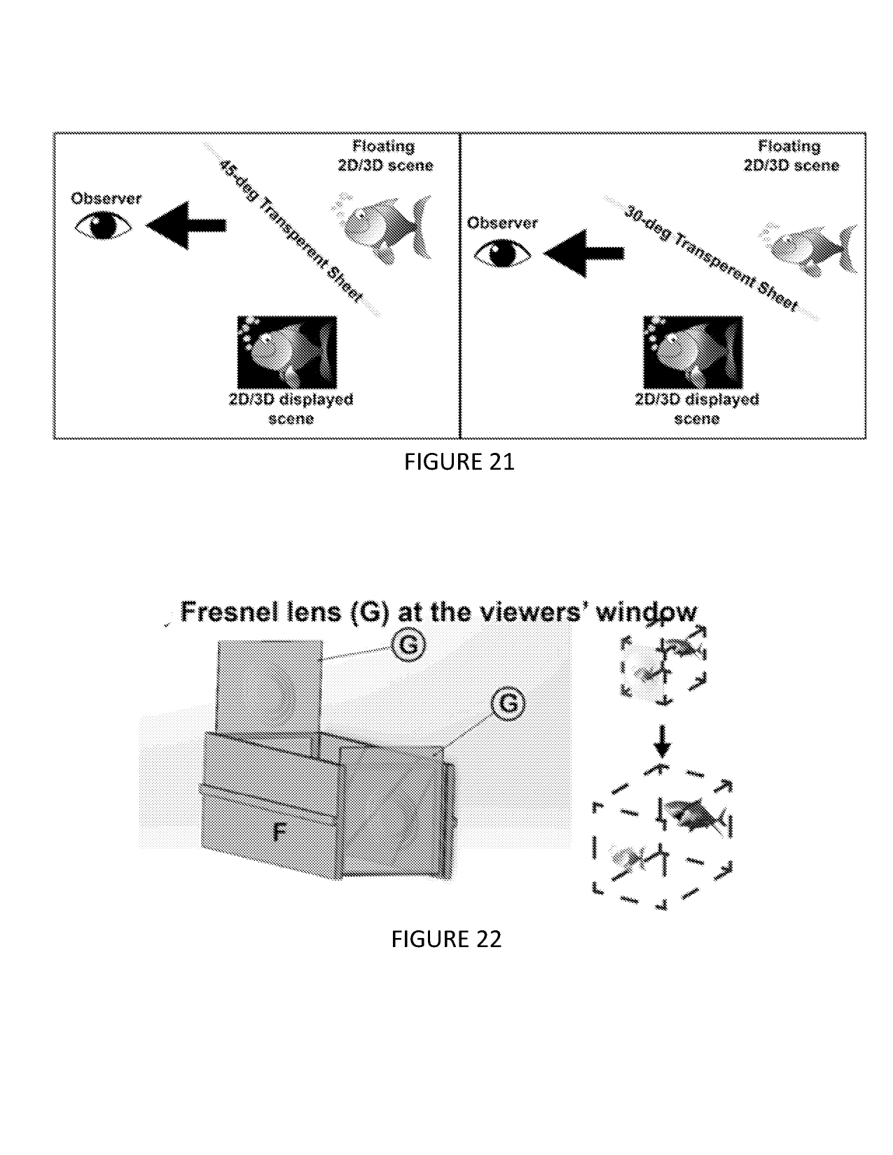

Axial displacement, or sliding, of the inner frame F, also allows for the removal and rearrangement of the transparency sheets to produce different optical effects. Referring to FIGS. 19-21, the transparency sheets could be inserted at different angles, introducing a vertical distortion on the floating image with respect to the displayed one. Whereas 45-deg transparent sheets will generate an exact replica of the displayed image (i.e., same horizontal and vertical dimensions), the sheets placed at a different angle will lead to a vertically distorted image (i.e., the ratio between the vertical dimensions in the displayed and floating scene differs from 1). Angles higher and lower than 45 degrees will provide a vertically magnified and de- magnified floating scene, respectively. FIG. 21 shows the difference in the vertical dimension of the floating image for an angle of 45 degrees (left side) and 30 degrees (right side) in the transparent sheet. The disclosed STEM toy will allow children to visualize this vertical distortion, exposing them to vertical and horizontal magnification.

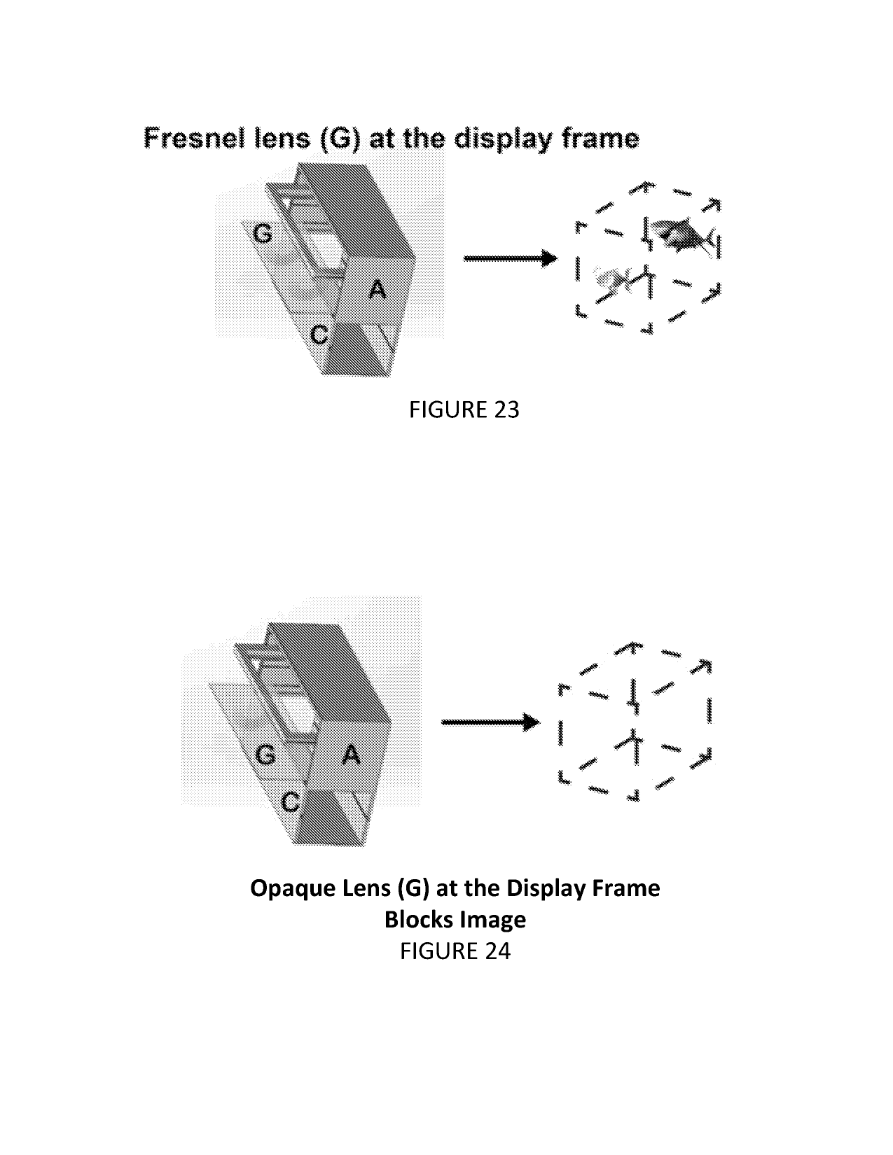

Referring to FIGS. 22 and 23, the dimensions of the floating 2D/3D scene can be increased using a Fresnel lens (G). The Fresnel lens is a type of optical lens that is

characterized by its flat, thin design and stepped surface. Fresnel lenses are widely used in various applications due to their lightweight, compact structure and efficient light-gathering properties. Opposed to traditional lenses that are thick and present curved surfaces, a Fresnel lens is composed of a series of concentric grooves that are carved into a flat, transparent glass or plastic. A common application of Fresnel lenses is magnifying glasses, enlarging texts or images. The floating 2D/3D scenes can be magnified for the viewers by inserting a Fresnel lens onto the display devices using slots in A and B parts (FIGS. 23). Another potential location of the Fresnel lens is at the opposing ends of the viewing tunnel (FIG. 22). Whereas the insertion of the Fresnel lens in parts A and B may only magnify one of the floating 2D/3D scenes, all the floating scenes would be magnified if the Fresnel lens is set at the viewers’ window.

Referring to FIG. 24, the disclosed double-side multiplane imaging display device becomes a one-side multiplane imaging device if part G in FIG. 24 is an opaque screen or panel. By blocking a viewer’s window, the children would notice the double-sided distinction of the apparatus. The displayed scenes on the top screen/s are only visible through the right viewer’s window, whereas the displayed scenes on the bottom screen/s are only observable through the left viewer’s window.

Among the many objectives of the invention are the following:

- Providing a STEM Toy for generating two-simultaneous three-dimensional (3D) scenes, comprising:

-- at least two transparent sheets

-- at least two screens (one top and one bottom)

-- set of two lateral walls

-- set of two side mounts for the viewer

-- set of two screen holders (one top and one bottom)

-- set of two opaque screen holders

- Providing a toy assembly which can be 3D printed in plastic or manufactured from wood products.

- Providing a STEM toy which has features that promote creativity, imagination, and cognitive development while being safe for children aged 3 to 18.

- Providing a STEM toy which introduces children to optics’ concepts, exposing them to refraction law, lateral magnification, optical two-dimensional projection, and three- dimensional imaging.

- Providing a STEM toy which is an interdisciplinary STEM toy, integrating concepts from optics, sensors, and microcontrollers into the same toy.

- Providing a construction of the toy assembly that is children-friendly (i.e., children can assemble it without requiring complex tools or adult assistance). The assembly of the STEM toy is designed to be intuitive and straightforward, allowing children to experience a sense of accomplishment and independence as they build and play with the toy. In particular, our design includes snap-together models (i.e., model kits where the individual components can be easily connected or snapped together without the need for glue, adhesive, or other fasteners) and construction sets with large, chunky pieces that are easy for small hands to manipulate.

- Providing a screen holder for the STEM toy which receive and/or be exchanged for mobile phones, individual small sensors like Raspberry Pi screen displays, or large screen displays.

- Providing a STEM toy comprising a double-side multiplane imaging display device with two simultaneous and distinct 2D/3D scenes.

- Providing an opaque screen holders which can block one of the double-sided 3D floating scenes, thus becoming a one-sided 3D multiplane display device.

- Providing a 3D STEM toy wherein 3D scenes for each plane can be achieved by implementing traditional stereoscopic approaches, including the display of two separate images of the same scene with different polarization or color.

- Providing a 3D imaging STEM toy wherein the viewer may wear polarized or color anaglyph goggles to visualize the 3D scenes.

- Providing a 3D imaging STEM toy wherein the transparent refracting sheets can be mounted on a movable/sliding platform whose axial location can be modified by the user Translating the platform with the sheets with respect to the screens changes the axial location (i.e., depth) of the scene elements.

- Providing a 3D imaging STEM toy wherein the dimensions of the floating images can be magnified by using optional Fresnel lenses which may be located at the screen holder and have a separation between the display element and the Fresnel lens. In this position, one only

magnifies the floating image of a single display element or located at the side mount for the viewer, magnifying the floating images of all display elements along a directional view.

- Providing a 3D imaging STEM toy wherein the floating image generated for each multiplane display element can be vertically distorted by placing the transparent sheets at an angle different than 45 degrees.

- Providing a 3D imaging STEM toy wherein angles of the transparency sheet higher and lower than 45 degrees will provide, respectively, a vertically magnified and de-magnified floating scene.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A backward refraction imaging device, comprising:
a modular, interlocking housing system including a central image viewing tunnel, an upper image projection housing, and a lower image projection housing;
two spaced transparency sheets disposed in inner wall channels in the central image viewing tunnel; and
an upper and lower display holder frames slidably positioned into the upper and lower image projection housings wherein the display holder frame support LCD display devices to project lighted images upwardly and downwardly into the image viewing tunnel,
wherein the images are backwards refracted by the transparency sheets to create 3D images viewable from each end of the image viewing tunnel.

2. The backward refraction imaging device of claim 1, wherein the upper and lower image projection housings include removable front panels or doors to enclose the display devices and enhance brightness of the lighted display images into the viewing tunnel.

3. The backward refraction imaging device of claim 1, wherein the display holder frames have a single rectangular frame for a single display panel or a single frame with two spaced frame openings for two separate side-by-side display panels.

4. The backward refraction imaging device of claim 1, wherein the image viewing tunnel include vertical lens slots at each end of the viewing to receive magnifying (Fresnel) lenses.

5. The backward refraction imaging device of claim 1, wherein the upper and lower image projection housings include horizontal panel slots so as to be located between the image projection housings and the image viewing tunnel to receive either a magnifying (Fresnel) lens or an opaque blocking panel.

6. The backward refraction imaging device of claim 1, wherein the image viewing tunnel includes a sliding inner frame which allow the user to slide the frame outwardly of the main tunnel to easily reposition the transparency sheets.

7. The backwards refraction imaging device of claim 1, wherein one spaced transparency sheet is disposed at an angle higher than forty-five-degrees to the image viewing tunnel, producing a vertically magnified floating scene.

8. The backwards refraction imaging device of claim 1, wherein one spaced transparency sheet is disposed at an angle lower than forty-five-degrees to the image viewing tunnel, producing a vertically de-magnified floating scene.

9. A backward refraction imaging device, comprising:
a housing system including a central image viewing tunnel, an upper image projection housing, and a lower image projection housing;
two spaced transparency sheets disposed at angles within the central image viewing tunnel;
upper and lower display holder frames positioned within the upper and lower image projection housings wherein the display holder frame support LCD display devices to project lighted images upwardly and downwardly onto the two spaced transparency sheets,
wherein the images are viewable from each end of the image viewing tunnel.

10. The backward refraction imaging device of claim 9, wherein the upper and lower image projection housings include removable front panels or doors to enclose the display devices and enhance brightness of the lighted display images into the viewing tunnel.

11. The backward refraction imaging device of claim 9, wherein the display holder frames have a single rectangular frame for a single display panel or a single frame with two spaced frame openings for two separate side-by-side display panels.

12. The backward refraction imaging device of claim 9, wherein the image viewing tunnel include vertical lens slots at each end of the viewing to receive magnifying (Fresnel) lenses.

13. The backward refraction imaging device of claim 9, wherein the upper and lower image projection housings include horizontal panel slots so as to be located between the image projection housings and the image viewing tunnel to receive either a magnifying (Fresnel) lens or an opaque blocking panel.

14. The backward refraction imaging device of claim 9, wherein the image viewing tunnel includes a sliding inner frame which allow the user to slide the frame outwardly of the main tunnel to easily reposition the transparency sheets.

15. The backwards refraction imaging device of claim 9, wherein one spaced transparency sheet is disposed at an angle higher than forty-five-degrees to the image viewing tunnel, producing a vertically magnified floating scene.

16. The backwards refraction imaging device of claim 9, wherein one spaced transparency sheet is disposed at an angle lower than forty-five-degrees to the image viewing tunnel, producing a vertically de-magnified floating scene.

17. A backward refraction imaging device, comprising:
a housing system including a central image viewing tunnel, an upper image projection housing, and a lower image projection housing;
two spaced transparency sheets disposed at angles within the central image viewing tunnel;
upper and lower display devices positioned within the upper and lower image projection housings wherein the display devices are configured to project lighted images upwardly and downwardly onto the two spaced transparency sheets,
wherein the images are viewable from each end of the image viewing tunnel.

18. The backward refraction imaging device of claim 17, wherein the image viewing tunnel include vertical lens slots at each end of the viewing to receive magnifying (Fresnel) lenses.

19. The backward refraction imaging device of claim 17, wherein the upper and lower image projection housings include horizontal panel slots so as to be located between the image projection housings and the image viewing tunnel to receive either a magnifying (Fresnel) lens or an opaque blocking panel.

20. The backwards refraction imaging device of claim 17, wherein the two transparency sheets may be disposed at an angle higher or lower than 45 degrees, producing a vertically magnified or de-magnified floating scene, respectively, in the image viewing tunnel.
